(19) United States
(12) Patent Application Publication
(10) Pub. No.: US 2020/0077630 A1
(43) Pub. Date: Mar. 12, 2020

(54) FEEDING DEVICE FOR A CLOSED PEN AND METHOD FOR DISTRIBUTION OF FEED IN A CLOSED PEN

(71) Applicant: Akvadesign AS, Brønnøysund (NO)

(72) Inventors: Anders Næss, Brønnøysund (NO); Trond Otto Johnsen, Brønnøysund (NO)

(73) Assignee: Akvadesign AS, Brønnøysund (NO)

(21) Appl. No.: 16/610,310

(22) PCT Filed: May 16, 2018
(86) PCT No.: PCT/NO2018/050129

§ 371 Date: Nov. 1, 2019

(30) Foreign Application Priority Data
May 19, 2017 (NO) 20170822

(51) Int. Cl. A01K 61/80; A01K 61/10

(52) U.S. Cl. CPC A01K 61/80; A01K 61/10

(57) ABSTRACT

A feeding system is for a closed pen for fish farming. The closed pen is provided with a water-supply system including a supply pipe which, at its upper portion, is provided with a housing with a lower portion, a middle portion and an upper portion, there being, extending from the middle portion of the housing, a feeding pipe which is arranged to convey water that is entering the housing at the lower portion to the inside of the closed pen. The feeding system includes a feed hopper and a feeder for carrying a feed out of the feed hopper and up to a mouth. The mouth is positioned at the upper portion of the housing. The housing is provided with a passage between the upper portion and the middle portion so that the feed is carried in the water and into the closed pen.

### CROSS-REFERENCE TO RELATED APPLICATIONS

This application is the U.S. national stage application of International Application PCT/NO2018/050129, filed May 16, 2018, which international application was published on Nov. 22, 2018, as International Publication WO 2018/212666 in the English language. The International Application claims priority of Norwegian Patent Application No. 20170822, filed May 19, 2017. The international application and Norwegian application are both incorporated herein by reference, in entirety.

### FIELD

The invention relates to a feeding device for feeding fish in a closed pen. More particularly, the invention concerns carrying the feed from a feed hopper, or some other container for feed, into a water flow entering the closed pen. The water flow is preferably carried into the closed pen at the upper portion of the pen. The water flow is created by means of a pump. Even more particularly, the invention concerns carrying the feed into an upper portion of a housing in which a pump creates an upward water flow in the lower portion of the housing, and in which water and feed flow out of the housing in a middle portion through a substantially horizontal feeding pipe and into the pen through the feeding pipe. On the inside of the pen, the feeding pipe may form a bent mouth piece for water and feed to be carried in a substantially horizontal and circular water flow on the inside of the pen.

### BACKGROUND

Conventionally, fish farming in the sea is done in so-called open pens. An open pen comprises a net which forms a closed, but water-permeable, enclosure for the fish. The pen is kept afloat by means of a surrounding buoyancy system. The pen also includes a mooring system.

Open pens have some drawbacks. A drawback to salmonoid farming is that fish may become infected with crustacean parasites, such as the salmon louse. The fish may also become infected with other diseases which may be due to viruses, bacteria and parasites. The fish may escape, especially when, accidentally, tears are formed in the net. An open pen emits waste products, such as uneaten feed and faeces, into a recipient. The water temperature within the pen follows the temperature of the surrounding water. In winter, the water temperature, especially near the surface, may be too low for the fish to grow optimally. In summer, the water temperature may too high for the fish to grow optimally.

A closed farming pen is an alternative to an open pen. A closed pen solves some of the problems connected to an open pen. Closed farming pens are known in the trade. The applicant's own patent document WO 2014/123427 shows a closed pen formed from a tight cloth material which forms a bag. Closed pens that are formed from a rigid material are known as well. Patent document NO 166511 discloses a semi-submersible floating platform which comprises cylindrical silos provided with a cone-shaped lower portion. Patent document 165783 discloses a hull-shaped container for fish. Patent document WO2010/016769 discloses a fish pen made of a watertight and substantially rigid material, the pen being substantially hemispherical. Patent document WO2010/099590 discloses a pen made up of watertight fibre-glass panels with an intermediate foam material to provide buoyancy. The pen is substantially cylinder-shaped with a flat bottom.

Common to closed pens formed from a material in cloth form or a rigid material, is that water will have to be pumped into the pen to maintain a water quality satisfactory to the fish inside the pen. In particular, it is important that the oxygen content of the water is sufficient. Water is pumped into the pen at the upper portion of the pen through a horizontal supply pipe. In its end portion inside the pen, the supply pipe is provided with a fixed or rotatable outlet. The direction of the outlet makes entering water flow in the desired directions horizontally and vertically inside the closed pen. In its lower portion, the lower part of the pen may be provided with an outlet which retains fish, but which allows outflowing water to pass. An example of such an outlet is shown in patent document WO 2014/123427.

Buoyancy systems for floating farming pens may consist of rectangular walkways in steel that are provided with buoyancy bodies. The walkways are interconnected by hinges. The walkways form a grid with longitudinal and transverse walkways. A buoyancy system like that is usually used together with open pens. The net, forming the enclosure for fish, is positioned in a square and secured to the surrounding walkways, on hooks projecting from special uprights or supports.

The buoyancy system for floating farming pens may also consist of at least one plastic pipe which has been welded together into a ring. Usually, the buoyancy system consists of two concentric rings side by side. Plastic pens with three concentric plastic rings are also known. The plastic rings are connected by radially oriented brackets in plastic or steel. Walkways may be placed on top of two concentric rings. In an open pen, the net is placed within the innermost pipe of the buoyancy system and is attached with projecting net hooks. The net hooks may be attached to the pipe or to a railing projecting up from the buoyancy system. The circumference for the net in a plastic pen may be for example between 90 m and 160 m, corresponding to a diameter of approximately between 30 m and 50 m.

It is known that a closed pen formed from a material in cloth form may be provided with a buoyancy system consisting of two concentric plastic rings as described in the above. Other buoyancy systems are also known, as described in the applicant's own patent U.S. Pat. No. 9,321,511 and patent document WO 2016/039632.

Known, closed pens remedy some of the drawbacks connected to an open pen. Known, closed pens, too have some drawbacks.

It is known that feed in the form of dry feed pellets is supplied to an open pen or a closed pen through a feed spreader. The feed spreader is usually connected to a feed blower which blows the feed through a hose from a feed barge to the pen. The feed barge may be provided with a plurality of feed silos. The hose may float on a water surface. The feed spreader is arranged to spread the feed over the water surface inside the pen. A feed spreader that comprises a special container for fish feed and a feeder is known as well. Such feed spreaders are used in particular on land, for dispensing feed into farming vessels. The feeder projects above a water surface in the vessel, and the feed is carried forward in the feeder. The feeder may include a screw in a pipe. A feeding system in which the feed is given below the water surface is known as well.

The feed, which has been spread over the surface in a pen, will sink down a water column and be eaten by the fish in the pen. The feed sinks substantially vertically downwards in the water column. The feed is available to the fish while the feed is in the water column within the enclosure. That is to say, the sinking rate of the feed determines when the feed will disappear out of the enclosure at the bottom of an open pen. In a closed pen, the feed will settle onto the bottom and be carried to an outlet. In an open pen, feed may also be carried out sideways with the water flow. Feed that is spread out near the net wall and/or downstream in a horizontal water flow through the enclosure will quickly be carried out of the enclosure.

Dry feed pellets include some smaller feed particles, also called feed dust. This lies on the surface of the feed pellets. These feed particles form during the production of the feed, transport and storage of the feed and during blow-out of the feed to the feed spreader. In the same way as the rest of the feed pellets, the feed dust also contains fat. Feed for salmonoids may contain 30% fat, and feed for salmonoids may contain more than 30% fat. The fat is added to the feed pellets as an oil, either as a fish oil, or as a vegetable oil, or as a mixture of fish oil and vegetable oil. The feed pellets may also include a coating of free fat on the surface. Some of the feed dust and some of the free fat is washed off the surface of the feed pellets when they hit the water surface and as they sink downwards in the water column. Free fat and light feed dust will gather in the water surface and form a film or a coat inside the pen. In an open pen, this film or coat will attach to the upper portion of the enclosure, to a jump net that projects above the water surface, and to other surfaces inside the pen, such as the feed spreader, a bird-net stand and other equipment. This makes the pen appear dirty. In a closed pen, the film or the coat attaches to the wall of the pen at the water surface, forming a brown or yellow mass on the wall.

There is thus a need for feeding equipment that gives good spreading of the feed in an enclosure for fish farming. There is further a need for feeding equipment that distributes the feed in such a way that it stays in the water column inside the enclosure for a long time, to increase the likelihood of the feed being eaten. There is further a need for feeding equipment that at least reduces the amount of feed dust and fat gathering on the water surface inside the enclosure. Dirtying of the equipment and walls inside the enclosure is thereby avoided as well.

### SUMMARY

The invention has for its object to remedy or reduce at least one of the drawbacks of the prior art or at least provide a useful alternative to the prior art.

The object is achieved through the features that are specified in the description below and in the claims that follow.

In a first aspect, the invention relates more specifically to a feeding system for a closed pen for fish farming, the closed pen being provided with a water supply system which includes a supply pipe that, in its upper portion, is provided with a housing having a lower portion, a middle portion and an upper portion, there being, extending from the middle portion of the housing, a feeding pipe which is arranged to convey water that is entering the housing at the lower portion to the inside of the closed pen. The feeding system includes a feed hopper and a feeder for carrying a feed out of the feed hopper and up to a mouth. The mouth is positioned at the upper portion of the housing. The housing is provided with a passage between the upper portion and the feeding pipe, so that the feed is carried in the water and into the closed pen. The passage between the upper portion and the feeding pipe is open, so that the feed that comes out of the mouth falls freely into a water flow. The water flow enters the housing in the lower portion of the housing, flows upwards in the housing and flows out of the housing through the feeding pipe.

The feeding pipe may have its mouth below a water surface inside the enclosure of the pen. The water flow through one feeding pipe may be sufficient to supply the closed pen with enough water.

The closed pen may be provided with a plurality of feeding pipes. The closed pen may be provided with a plurality of feeding systems. The closed pen may be provided with as many feeding systems as the number of feeding pipes. The closed pen may be formed with a wall made of a watertight material in cloth form. The closed pen may be formed with a wall made of a watertight, rigid material, such as concrete or a rigid plastics material. The rigid wall may be reinforced. The rigid wall may be formed from a laminated material.

On the inside of the pen, the feeding pipe may be formed with a bent mouth piece. The bent mouth piece may be formed in a substantially horizontal plane. The water flowing out of the mouth piece will form a circular water flow flowing substantially horizontally inside the closed pen.

The feeder may consist of an auger. The auger may be positioned in an open pipe, or a partially open pipe. The auger may be positioned in a closed pipe. At its free end portion, the open pipe, the partially open pipe or the closed pipe forms a mouth or an ejector. A feed which is moved forward in the feeder falls down from the mouth or the ejector. The feeder may be a conveyor belt. At its free end portion, the conveyor belt forms an ejection device. The feeder may be a rotating disc provided with one or more guiding walls. The at least one guiding wall guides the feed up to a portion where the feed falls off the rotating disc. This portion is the ejector of the rotating disc.

The pump may be positioned at the lower portion of the housing. The pump is positioned lower than a nozzle opening of the internal, bent mouth piece. The pump may be positioned at a lower portion of a water-supply system. The water-supply system may extend downwards in the water column. The pump may be a mammoth pump. The pump may be a positive-displacement pump. The pump may be positioned internally in the housing.

The mouth or the ejector may be positioned at the vertical centre axis of the housing. The has the advantage of the feed rotating with the water flow rotating in the housing because of the hydrodynamic conditions. The feed will stay centred in the feeding pipe. Thereby, there is little or no contact between the feed and the internal walls of the housing and the feeding pipe, and there is no formation of feed dust.

In a second aspect, the invention relates more specifically to a method for the distribution of a feed in a closed pen, the method comprising providing a feed hopper containing the feed, and a feeder for carrying the feed out of the feed hopper and up to a mouth, and the method further comprising providing the closed pen for fish farming, the pen being provided with a water-supply system for carrying a water from the outside into the closed pen, and the method comprising carrying the feed from the mouth into a water flow which is flowing through the water-supply system.

The method may further include providing the water-supply system within the pen with a bent mouth piece, and carrying the feed in the water flow in a substantially horizontal direction out into the water inside the closed pen. This has the advantage of the feed in the water flow being carried in the horizontal water flow and not just sinking vertically according to the sinking properties of the feed. It also has the advantage of the feed being distributed around the pen, even if the feed is carried into the pen in the area consisting of the nozzle opening of the mouth piece. The nozzle opening may be positioned under a water surface. The pen may be provided with several water-supply systems and feeding systems. Thereby very good distribution of the feed in the enclosure is achieved. Salmonoids swim against the direction of flow. In an enclosure according to the invention, salmonoids will experience good and even food supply without competing with other salmonoids for the feed. This reduces the stress level in the population in the enclosure.

### BRIEF DESCRIPTION OF THE DRAWINGS

In what follows, an example of a preferred embodiment is described, which is visualized in the accompanying drawings, in which:

FIG. 1 shows a floating, closed pen for fish farming with a feeding device according to the invention, viewed from the side;

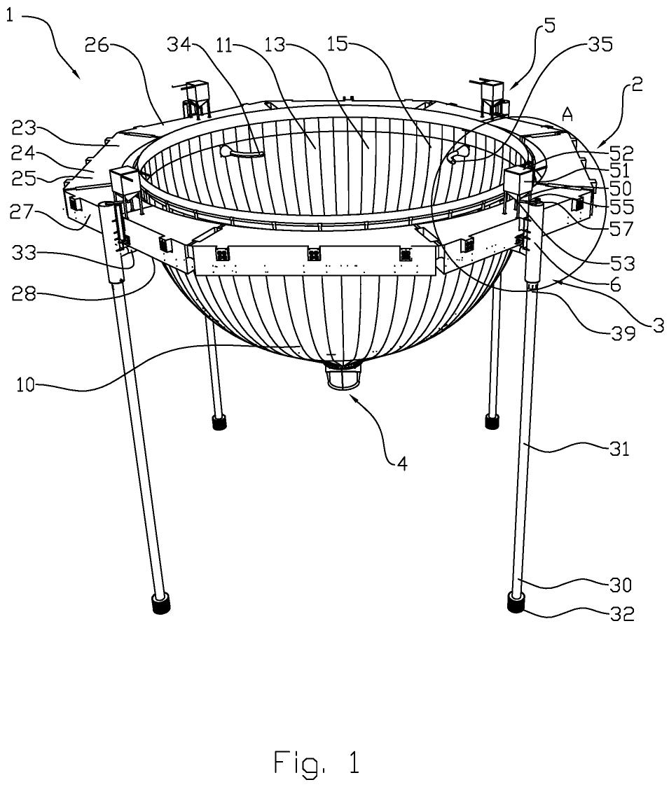

FIG. 2 shows the same as FIG. 1, viewed somewhat at an angle from above;

FIG. 3 shows a detail A from FIG. 1 on a larger scale; and

FIG. 4 shows a detail B from FIG. 2 on a larger scale.

### DETAILED DESCRIPTION OF THE DRAWINGS

In the drawings, the reference numeral 1 indicates a closed pen. The pen 1 includes a closed enclosure 11 for fish, a buoyancy system 2, a water-supply system 3, a drain 4 and a feeding system 5. The pen 1 further comprises a mooring system (not shown), and the pen 1 may further comprise an electrical cable extending to shore, for energy supply (not shown).

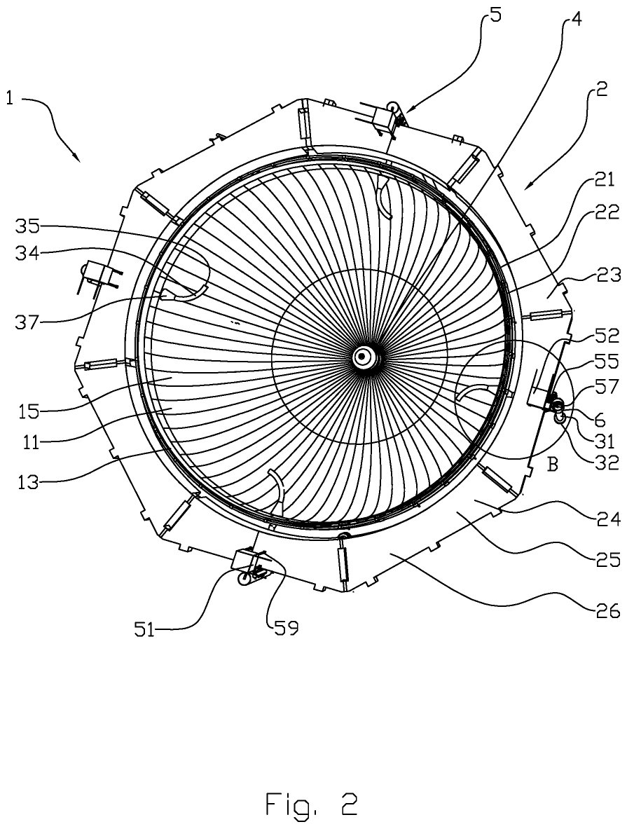

The closed enclosure 11 is formed from a watertight material 13 in cloth form. The closed pen 1 is kept afloat by the enclosure 11 being attached to the buoyancy system 2. The buoyancy system 2 is shown as an inner buoyancy system 21 (see FIG. 2). The inner buoyancy system 21 comprises at least one annular buoyancy body 22 surrounding the enclosure 11. The buoyancy system 2 further comprises an outer buoyancy system 23. The outer buoyancy system 23 is shown as a modular buoyancy system 24 which is made up of buoyancy elements 25. A plurality of buoyancy elements 25 are connected to each other and surround the inner buoyancy system 21.

In an alternative embodiment, the enclosure 11 may be attached to the outer buoyancy system 23. In this embodiment, an inner buoyancy system 21 will not be necessary.

Each buoyancy body 25 is formed with a substantially horizontal platform 26 at its top. The platform 26 is large enough for storing equipment and feed. Because of the size of the buoyancy element 25, the platform 26 will be relatively stable, even when affected by waves.

The buoyancy element 25 may be formed from concrete. A buoyancy element 25 as described in patent document WO 2016/039632 is suitable for the purpose.

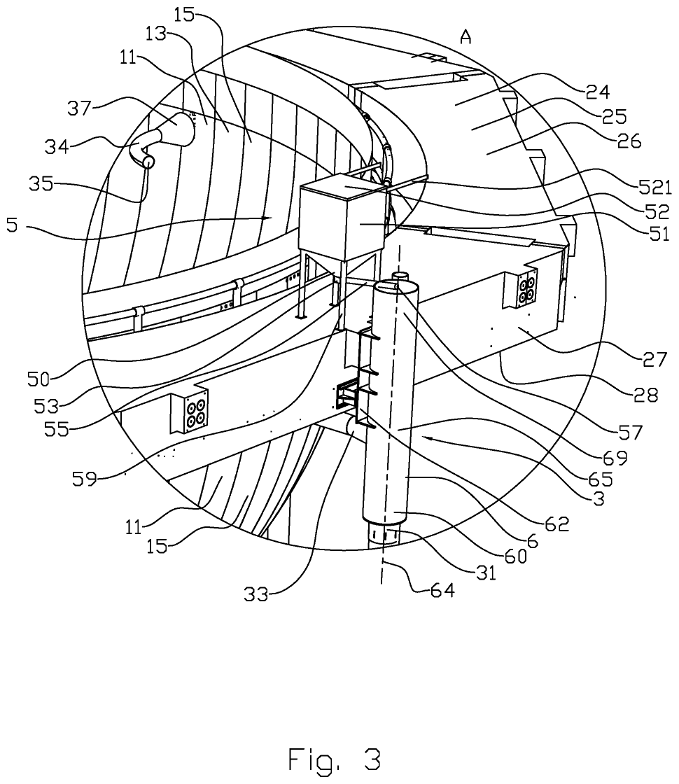

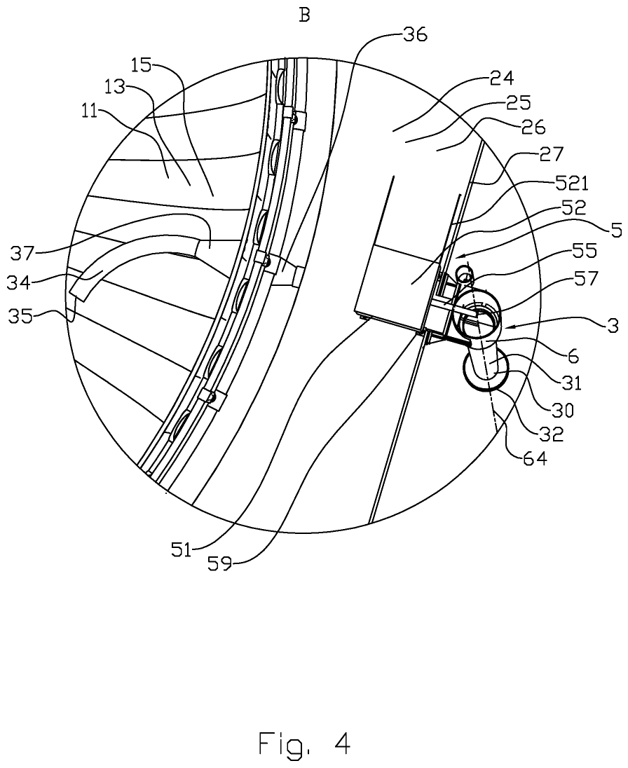

The water-supply system 3 comprises a supply pipe 31 extending down a water column. In a lower end portion 30, the supply pipe 31 is shown provided with a filter 32. At its upper end portion 39, the supply pipe is provided with a housing 6. The housing 6 forms a lower portion 60, a middle portion 65 and an upper portion 69. A pump (not shown) is positioned inside the housing 6 at the lower portion 60 and below a feeding pipe 33. The feeding pipe 33 extends substantially horizontally out from the middle portion 65 of the housing 6 in a direction towards the centre portion of the enclosure 11 (see FIG. 3). The housing 6 is shown attached to the outer side 27 of the buoyancy element 25 with a bracket 62. The feeding pipe 33 extends from the housing 6, under a bottom side 28 of the buoyancy element 25, under the inner buoyancy system 21 and through an opening (not shown) formed in the enclosure 11. On the inside of the enclosure 11, the feeding pipe 33 is formed with a bent mouth piece 34 so that the mouth piece 34 forms a nozzle opening 35 which is oriented for carrying an entering water in a substantially horizontal direction along the wall 15 of the enclosure 11. The nozzle opening 35 is positioned under the water surface. The entering water will form and maintain a circular water flow inside the enclosure 11. The feeding pipe 33 is provided with an external sealing collar 36 on the outside of the wall 15 and with an internal sealing collar 37 on the inside of the wall 15. The external collar 36 and the internal collar 37 cover the passage of the feeding pipe 33 in the wall 15 so that the passage will be watertight as shown in FIG. 4.

The drain 4 is shown positioned in the lower portion 10 of the enclosure 11. The drain 4 is provided with filters or grills for letting water drain from the enclosure 11 while fish is retained in the enclosure 11 at the same time. The drain 4 may be arranged to carry feed remains, mud and faeces to a special first outlet (not shown). The drain 4 may be arranged to carry dead fish to a special second outlet (not shown). Such a drain 4 is described in patent document WO 2014/123427 and will not be described in further detail.

The feeding system 5 includes a feed hopper 51 with a displaceable lid 52, a feeder mechanism 53 at the lower portion 50 of the feed hopper and a dispenser pipe 55. The dispenser pipe 55 is provided with an internal feeding screw (not shown) for displacing the feed from the feed hopper 51 to the mouth 57 of the dispenser pipe 55. The feed hopper 51 is provided with a stand 59, and the stand 59 is secured to the platform 26. The feed hopper 51 is shown with a guide 521 enabling the lid 52 to be slid between an open position and a closed position.

The feeding system 5 is positioned on the platform 26 by the housing 6. The mouth 57 is shown positioned in the upper portion 69 of the housing 6. In an alternative embodiment (not shown), the mouth 57 may be position right above the housing 6. The mouth 57 may be positioned at the longitudinal axis 64 of the housing 6.

The feed hopper 51 may be arranged to be filled with feed from a bulk bag (not shown) which is emptied when it is has been moved over the feed hopper 51 and the lid 52 has been displaced into the open position. In an alternative embodiment, the feed hopper 51 may be arranged to be filled with feed from a central feed store (not shown) through a hose (not shown). The feed may be conveyed pneumatically to the feed hopper 51. In this embodiment, the feed hopper 51 may be provided with a cyclone (not shown) to lower the speed of the feed particles before they are carried into the feed hopper 51.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1-7. (canceled)

8. A feeding system for a closed pen for fish farming, the closed pen being provided with a water-supply system including a supply pipe which, at its upper portion, is provided with a housing with a lower portion, a middle portion and an upper portion, there being, extending from the middle portion of the housing, a feeding pipe which is arranged to convey water that is entering the housing at the lower portion to the inside of the closed pen, wherein the feeding system comprises a feed hopper and a feeder for carrying a feed out of the feed hopper and up to a mouth, and wherein the mouth is positioned at the upper portion of the housing and the housing is provided with a passage between the upper portion and the middle portion so that the feed from the mouth is carried in the water and into the closed pen through the feeding pipe.

9. The feeding system according to claim 8, wherein the feeding pipe on the inside of the pen is formed with a bent mouth piece.

10. The feeding system according to claim 8, wherein the feeder consists of an auger.

11. The feeding system according to claim 9, wherein the feeder consists of an auger.

12. The feeding system according to claim 8, wherein a pump is positioned at the lower portion of the housing.

13. The feeding system according to claim 9, wherein a pump is positioned at the lower portion of the housing.

14. The feeding system according to claim 10, wherein a pump is positioned at the lower portion of the housing.

15. The feeding system according to claim 8, wherein the mouth is positioned at the vertical center axis of the housing.

16. The feeding system according to claim 9, wherein the mouth is positioned at the vertical center axis of the housing.

17. The feeding system according to claim 10, wherein the mouth is positioned at the vertical center axis of the housing.

18. The feeding system according to claim 11, wherein the mouth is positioned at the vertical center axis of the housing.

19. A method for distributing a feed in a closed pen, wherein the method comprises:
using a feeding system for the closed pen for fish farming, the closed pen being provided with a water-supply system including a supply pipe which, at its upper portion, is provided with a housing with a lower portion, a middle portion and an upper portion, there being, extending from the middle portion of the housing, a feeding pipe which is arranged to convey water that is entering the housing at the lower portion to the inside of the closed pen, wherein the feeding system comprises a feed hopper and a feeder for carrying a feed out of the feed hopper and up to a mouth, and wherein the mouth is positioned at the upper portion of the housing and the housing is provided with a passage between the upper portion and the middle portion so that the feed from the mouth is carried in the water and into the closed pen through the feeding pipe

20. The method according to claim 19, further comprising providing the water-supply system inside the closed pen with a bent mouth piece, and carrying the feed in the water flow in a substantially horizontal direction out into the water inside the closed pen.
